(19) United States
(12) Patent Application Publication
(10) Pub. No.: US 2013/0074851 A1
(43) Pub. Date: Mar. 28, 2013

(54) DENTAL APPLIANCE

(71) Applicants: Mark H. Herman, Minneapolis, MN (US); Paul C. Belvedere, Edina, MN (US); William Cook, Lakeville, MN (US)

(72) Inventors: Mark H. Herman, Minneapolis, MN (US); Paul C. Belvedere, Edina, MN (US); William Cook, Lakeville, MN (US)

(73) Assignee: BITE TECH, INC., Norwalk, CT (US)

(21) Appl. No.: 13/701,481

(22) PCT Filed: May 31, 2011
(86) PCT No.: PCT/US11/38644

§ 371 Date: Nov. 30, 2012

Related U.S. Application Data
(60) Provisional application No. 61/350,253, filed on Jun. 1, 2010.
(60) Provisional application No. 61/350,270, filed on Jun. 1, 2010.

(51) Int. Cl. A61C 5/14

(52) U.S. Cl. CPC A61C 5/14
USPC 128/861

(57) ABSTRACT

A dental appliance is disclosed herein. The dental appliance, in various aspects, includes arms disposed about occlusal pad to secure the dental appliance in a removable fashion to the teeth of the user. The occlusal pad is formed from an occlusal pad material transformable between a pliable state and a non-pliable state, in various aspects. Associated methods of use are also disclosed herein.

### CROSS-REFERENCE TO RELATED APPLICATIONS

This application claims the priority and benefit of U.S. Provisional Patent Application 61/350,270 filed 1 Jun. 2010 entitled “DENTAL APPLIANCE” and the priority and benefit of U.S. Provisional Patent Application 61/350,253 filed 1 Jun. 2010 entitled “APPARATUS AND METHODS FOR SECURING A DENTAL APPLIANCE,” which are incorporated herein by reference in their entirety.

### BACKGROUND OF THE INVENTION

1. Field

The present disclosure relates to dental appliances for use generally within the mouth including related methods.

2. Description of the Related Art

A dental appliance, in various aspects, may be a mouth guard that offers protection to the user while the user is engaged in various sporting or other physical activities. In various aspects, the dental appliance may provide various therapeutic effects or confer other generally beneficial physiological or psychological effects upon the user.

The dental appliance may be removably received within the mouth of the user. Although removably received within the mouth, the dental appliance must be secured within the mouth sufficiently to resist being displaced during use, in various aspects. For example, the dental appliance may be used during strenuous athletic activity when it may be subject to blows, jarring, and other such disturbances, and the dental appliance must maintain secure engagement with the mouth during such activity. Thus, there is a need for apparatus and associated methods for removably securing a dental appliance to the mouth of the user.

### BRIEF SUMMARY OF THE INVENTION

These and other needs and disadvantages are overcome by the methods, systems, and compositions of matter disclosed herein. Additional improvements and advantages may be recognized by those of ordinary skill in the art upon study of the present disclosure.

A dental appliance is disclosed herein. In various aspects, the dental appliance includes an occlusal pad formed from an occlusal pad material transformable between a pliable state and a non-pliable state. The occlusal pad defines a channel adapted to receive a tooth including at least a portion of the buccal-labial surface of the tooth and at least a portion of the lingual surface of the tooth and such that the occlusal pad covers a biting surface of the tooth. The dental appliance, in various aspects, includes an arm positioned on a buccal-labial side of the channel in cooperation with the occlusal pad to bias generally against the buccal-labial surface of the tooth, and an arm positioned on a lingual side of the channel in cooperation with the occlusal pad to bias generally against the lingual surface of the tooth generally opposite the buccal-labial surface

This summary is presented to provide a basic understanding of some aspects of the methods disclosed herein as a prelude to the detailed description that follows below. Accordingly, this summary is not intended to identify key elements of the methods, systems, and compositions of matter disclosed herein or to delineate the scope thereof.

### BRIEF DESCRIPTION OF THE DRAWINGS

FIG. 1A illustrates by perspective view an exemplary implementation of a dental appliance;

FIG. 1B illustrates by cross-sectional view portions of the exemplary implementation of the dental appliance of FIG. 1A;

FIG. 2 illustrates by perspective view portions of an exemplary implementation of a dental appliance;

FIG. 3A illustrates by cross-sectional view portions of an exemplary implementation of a dental appliance;

FIG. 3B illustrates by cross-sectional view portions of the exemplary implementation of the dental appliance of FIG. 3A;

FIG. 4A illustrates by perspective view an exemplary implementation of portions of a dental appliance;

FIG. 4B illustrates by cross-sectional view portions of the exemplary implementation of the dental appliance of FIG. 4A;

FIG. 4C illustrates by perspective view portions of the exemplary implementation of the dental appliance of FIG. 4A;

FIG. 5A illustrates by frontal view an exemplary implementation of a base with arms secured thereto;

FIG. 5B illustrates by cut-away side view portions of the exemplary implementation of FIG. 5A;

FIG. 6A illustrates by frontal view an exemplary implementation of a base with arms secured thereto;

FIG. 6B illustrates by cut-away side view portions of the exemplary implementation of FIG. 6A;

FIG. 7A illustrates by frontal view an exemplary implementation of a base with arms secured thereto;

FIG. 7B illustrates by cut-away side view portions of the exemplary implementation of FIG. 7A;

FIG. 8A illustrates by frontal view an exemplary implementation of a base with arms secured thereto; and

FIG. 8B illustrates by cut-away side view portions of the exemplary implementation of FIG. 8A.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof.

### DETAILED DESCRIPTION OF THE INVENTION

A dental appliance and related methods of using the dental appliance as well as related compositions of matter are disclosed herein. The dental appliance disclosed herein is generally receivable within the mouth of a user, and may be removably secured to at least a portion of the teeth of the user. In various aspects, the dental appliance may confer various therapeutic or protective benefits upon the user. Methods of securing the dental appliance to the teeth of the user are disclosed herein.

In various aspects, the dental appliance includes an occlusal pad. A channel may be formed in the occlusal pad, and the occlusal pad may be attached to a user's teeth by insertion of the teeth into the channel. With the teeth inserted into the channel, portions of the occlusal pad bias against the teeth to frictionally secure the occlusal pad to the teeth, in various aspects. In various aspects, the occlusal pad including the channel may be alterable in order to be custom fit to the specific user's teeth.

The dental appliance, in various aspects, includes arms that cooperate with the occlusal pad to aid in the attachment of the dental appliance to the teeth. The arms are at least partially embedded within the occlusal pad, and positioned on opposing sides of the channel, in various aspects. Accordingly, the arms may be generally biased against the teeth in opposing directions when the teeth are received within the channel such that the arms frictionally secure the dental appliance to the teeth. The arms may directly biased against the teeth, in some aspects, or portions of the occlusal pad may be interposed between the arms and the teeth as the arms bias against the teeth, in other aspects.

The arms may be composed of composed of one or more arm materials. The arm materials may include nylon, various plastics, various metals, and combinations thereof. The arm material may be generally linearly elastic within the expected range of operation in some aspects, and ruberous or other such non-linearly elastic material in other aspects. In various aspects, the arm material may include a mixture of styrene block copolymer and ethylene vinyl acetate (EVA). An exemplary styrene block copolymer is available as DYNAFLEX® part number G2782 from GLS Corporation, Thermoplastic Elastomers Division, 833 Ridgeview Dr., McHenry, Ill. 60050. EVA is available from a number of sources, such as the ELVAX® resins from Dupont Packaging and Industrial Polymers, 1007 Market Street, Wilmington, Del. 19898.

In various aspects, the arm material may include a mixture of a styrene block copolymer and a polyolefin elastomer. The polyolefin elastomer may be a copolymer of ethylene and octene-1. An exemplary copolymer is available as ENGAGE® from Dupont Canada, Inc., P.O. Box 2200, Streetsville, Mississauga, Ontario L5M 2H3.

The arm material may include, in various aspects, a mixture of a thermoplastic rubber, which includes thermoplastic elastomer and thermoplastic urethane, with a polyolefin elastomer. Exemplary thermoplastic rubbers are Santoprene® thermoplastic elastomer from Advanced Elastomer Systems, L. P., 388 South Main Street, Akron, Ohio 44311 and Kraton® thermoplastic elastomer from the Shell Oil Company, Houston, Tex. Kraton® includes a styrene-ethylenelbutylenes-styrene block copolymer. In various aspects, the arm material may include polypropylene part number AP6112-HS from Huntsman Corporation, Chesapeake, Va. 23320. In various aspects, the arm material may include HD-6706 ESCORENE® Injection Molding Resin (a high density polyethylene) from ExxonMobil Chemical Company, P.O. Box 3272, Houston, Tex. In some aspects, the arm material of the arm has a Shore A hardness of about 82.

The arms may be formed as a portion of a base in a unitary structure, in some aspects. The base including the arm portion may be formed of a base material of suitable hardness, elasticity, and other properties suitable to contact teeth that oppose the teeth to which the dental appliance is secured. Materials listed herein as exemplary arm materials may be used as the base material, in various aspects. In other aspects, the arms may be formed as a separate construction from the base, and the arms may then be attached to the base and/or occlusal pad by adhesive, solvent welding, various mechanical attachments, and so forth.

The occlusal pad may be composed of one or more occlusal pad materials. The occlusal pad material may be transformable between a pliable state and a non-pliable state. In the pliable state, the occlusal pad material of the occlusal pad may be shaped to fit the teeth of the user. In the non-pliable state, the occlusal pad material of the occlusal pad may generally retain its fit to the teeth of the user as shaped when in the pliable state. In various aspects, the occlusal pad may be transformed between the pliable state and the non-pliable state by heating and cooling, respectively. For example, heating the occlusal pad material in warm water may allow the occlusal pad to be fitted to the user's teeth and, after having been fitted, the occlusal pad material may be cooled to the non-pliant state thereby capturing the fit of the user's teeth in the occlusal pad material. The occlusal pad material is transformed from the non-pliable state to the pliable state at a temperature tolerable by the user upon placement of the occlusal pad material in the pliable state within the user's mouth, in various aspects. The occlusal pad material may transform between the non-pliant and pliant state at a temperature greater than human body temperature but less than about 100° C., in various aspects.

In various aspects, the occlusal pad material of the occlusal pad includes a mixture of polycaprolactone. An exemplary polycaprolactone is Capra 6500 polycaprolactone from Perstorp, UK Limited, Warrington, Cheshire UK. In various aspects, the occlusal pad material of occlusal pad 40 includes a mixture of polycaprolactone and ethylene vinyl acetate (EVA) such as ELVAX®. In various aspects, the occlusal pad material of occlusal pad includes ethylene vinyl acetate (EVA) alone, such as ELVAX®. In various aspects, the occlusal pad material of occlusal pad includes a mixture of polycaprolactone and a polyolefin elastomer, and the polyolefin elastomer may be a copolymer of ethylene and octene-1. An exemplary copolymer is available as ENGAGE® from Dupont Canada, Inc., P.O. Box 2200, Streetsville, Mississauga, Ontario L5M 2H3.

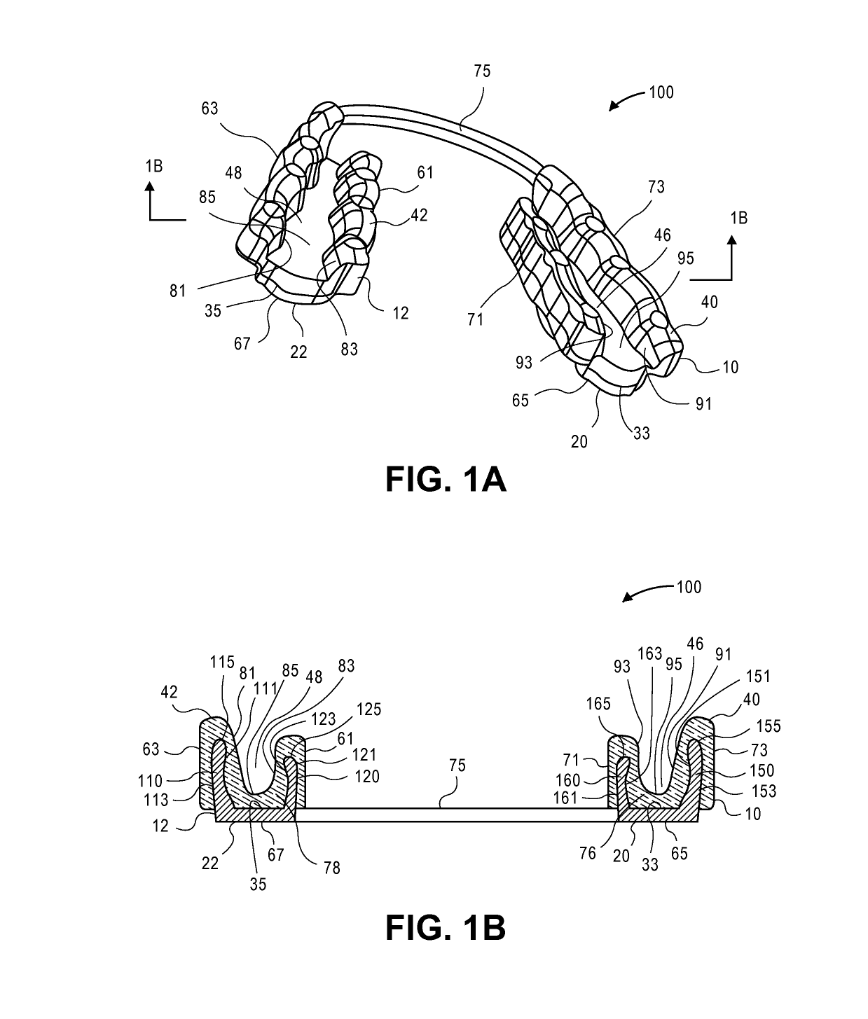

FIGS. 1A and 1B illustrate an exemplary implementation of a dental appliance 100. As illustrated in FIG. 1A, dental appliance 100 includes occlusal pads 40, 42 bonded to bases 20, 22 to form bite pads 10, 12, respectively. In this implementation, bite pad 10 and bite pad 12 are connected to one another by labial bar 75.

As illustrated in FIG. 1A, occlusal pads 40, 42 define occlusal pad channels 46,48, respectively, that engage posterior teeth on opposing sides of the mouth to secure the dental appliance 100 within the mouth. The dental appliance 100 may be removed from the mouth by disengagement of occlusal pad channels 46, 48 from the teeth. Accordingly, the exemplary dental appliance 100 is removably secured within the mouth. In the implementation illustrated in Figures lA and 1B, occlusal pad channels 46, 48 engage teeth generally in the posterior portion of the lower jaw such that the teeth are generally received within the channels 46, 48. The crowns of the teeth including the biting surfaces are thus generally received in occlusal pad channels 46, 48 and are generally engaged with sides 95, 85 of the occlusal pads 40, 42, respectively. The occlusal pads 40, 42 generally surround the teeth that are received in the occlusal pad channels 46, 48 and cover the biting surfaces of these teeth. In other implementations of a dental appliance (not shown), occlusal pad channels 46, 48 may engage teeth, for example, generally in the posterior portion of the upper jaw.

Occlusal pads 40, 42 may be bonded bases 20, 22, respectively, by overmolding the occlusal pads 40, 42 upon bases 20, 22. In various implementations, the occlusal pads 40, 42 and bases 20, 22 may bonded to one another, at least in part, by extrusion of molten occlusal pad material into indentations formed in the base so that the occlusal pad material is interdigitated with the base. Various adhesives, mechanical attachments, welding using heat and/or solvents, and so forth, and combinations thereof may be used to bond, at least in part, the occlusal pads 40, 42 and bases 20, 22 to one another in various implementations.

As illustrated in FIG. 1A, bite pad 10 and bite pad 12 are connected to one another by labial bar 75. Labial bar 75 may be formed of a variety of materials including those materials set forth herein as being suitable for use in the base, such as base 20, 22, or of other materials and combinations of materials, as would be recognized by those of ordinary skill in the art upon study of this disclosure. Labial bar 75 and bases 20, 22 may be formed as a unitary structure in some implementations. In other implementations, labial bar 75 may be attached to bases 20, 22 by, for example, various adhesives, mechanical connections, thermal bonding, and combinations thereof. In use, labial bar 75 may generally pass about the anterior teeth of the user when occlusal pad channels 46, 48 of occlusal pads 40, 42 are engaged with the user's posterior teeth. Labial bar 75 be attached to occlusal pads 40, 42 at various locations such that labial bar 75 may pass about either lingual or buccal-labial potions of the user's anterior teeth, in various implementations.

As illustrated in FIGS. 1A and 1B, occlusal pads 40, 42 overlie bases 20, 22 to form bite pads 10, 12, respectively, of dental appliance 100. Sides 65, 67 of bite pads 10, 12 are formed, at least in part, by bases 20, 22, and are generally oriented opposite to channels 46, 48, respectively. Accordingly, sides 65, 67 may interact with posterior teeth opposite to those engaged with occlusal pad channels 46, 48 of occlusal pads 40, 42. In the implementation of FIGS. 1A and 1B, occlusal pad channels 46, 48 of occlusal pads 40, 42 engage teeth of the lower jaw, so that sides 65, 67 may generally interact with teeth of the upper jaw opposite to those the teeth of the lower jaw engaged in channels 46, 48. Sides 65, 67 may include treads and so forth and may otherwise be adapted for interaction with teeth.

As illustrated in FIG. 1B, bite pad 10 of dental appliance 100 includes arms 150, 160 formed as a unitary structure with base 20, and arms 150, 160 are covered by occlusal pad 40. The arms 150, 160 may cooperate with occlusal pad 40 to attach the dental appliance 100 to the teeth. With continuing reference to the implementation of FIG. 1B, arms 150, 160 of base 20 extend forth such that side 163 of arm 160, side 33 of base 20, and side 151 of arm 150 define channel 76. Occlusal pad 40 is formed about base 20 such that portions of occlusal pad 40 lie within channel 76. Channel 76 is thus filled at least in part by the occlusal pad material of occlusal pad 40, in this implementation, and occlusal pad channel 46 lies, at least in part, within channel 76. Arms 150, 160 may lie generally proximate sides 91, 93, respectively, of occlusal pad channel 46. As illustrated, side 151 of arm 150 is positioned proximate side 91 of occlusal pad channel 46, and side 163 of arm 160 is positioned proximate side 93 of occlusal pad channel 46.

Accordingly, when teeth are engaged with occlusal pad channel 46 of bite pad 10, side 93 of occlusal pad channel 46 is generally engaged with the lingual surfaces of the teeth, and side 91 of occlusal pad channel 46 is generally engaged with the buccal-labial surfaces of the teeth. The tips of the teeth including the biting surfaces are generally biased against trough 95 of occlusal pad channel 46.

Side 161 of arm 160 is oriented in the lingual direction and side 163 of arm 160 is oriented in the buccal-labial direction, as illustrated. With teeth engaged with occlusal pad channel 46, side 163 of arm 160 is biased against portions of the lingual surface of the teeth, with portions of occlusal pad 40 proximate side 93 of occlusal pad channel 40 interposed between side 163 and the lingual surface of the teeth. In other implementations (not shown), arm 160 may be partially covered by occlusal pad 40 (i.e. portions of arm 160 emerge from the occlusal pad 40) such that at least portions of side 163 of arm 160 directly contact portions of the lingual surface of the teeth.

Side 153 of arm 150 is oriented in the buccal-labial direction, and side 151 of arm 150 is oriented in the lingual direction, as illustrated. With teeth received in occlusal pad channel 46, side 151 of arm 150 is biased against portions of the buccal-labial surface of the teeth, with portions of occlusal pad 40 proximate side 91 of occlusal pad channel 46 interposed between side 151 and the buccal-labial surface of the teeth, in this implementation. In other implementations (not shown), arm 150 may be positioned with respect to the occlusal pad 40 (i.e. portions of arm 150 emerge from the occlusal pad 40) such that at least portions of side 151 directly contact portions of the buccal-labial surface of the teeth.

Accordingly, in the implementation of FIG. 1B, when teeth are engaged with occlusal pad channel 46 of bite pad 10, the buccal-labial surfaces of one or more teeth push against arm 150, which forces arm 150 to flex in the buccal-labial direction from a relaxed position to a flexed position. Side 151 of arm 150 in the flexed position may be thus biased in tension against the buccal labial surfaces of the one or more teeth, with portions of occlusal pad 40 interposed between side 151 and the lingual tooth surfaces, in this implementation.

Similarly, in the implementation of FIG. 1B, when teeth are engaged with occlusal pad channel 46 of bite pad 10, the lingual surfaces of one or more teeth push against arm 160, which forces arm 160 to flex in the lingual direction from a relaxed position to a flexed position. Side 163 of arm 160 in the flexed position may be thus biased in tension against the lingual surfaces of the one or more teeth, in this implementation, with portions of occlusal pad 40 interposed between side 163 and the lingual tooth surfaces.

Arm 160 biased in the flexed position against the lingual surfaces one ore more teeth exerts a force thereupon generally acting in the buccal labial direction, in this implementation. Arm 150 in the flexed position biased in the flexed position against the buccal-labial surfaces of one or more teeth exerts a force thereupon generally acting in the lingual direction, in this implementation. Thus, in the implementation illustrated in FIG. 1B, arms 150, 160 exert forces upon the teeth in generally opposing directions, so that the teeth are clamped between arms 150, 160 thereby securing bite pad 10 of dental appliance 100 to the teeth.

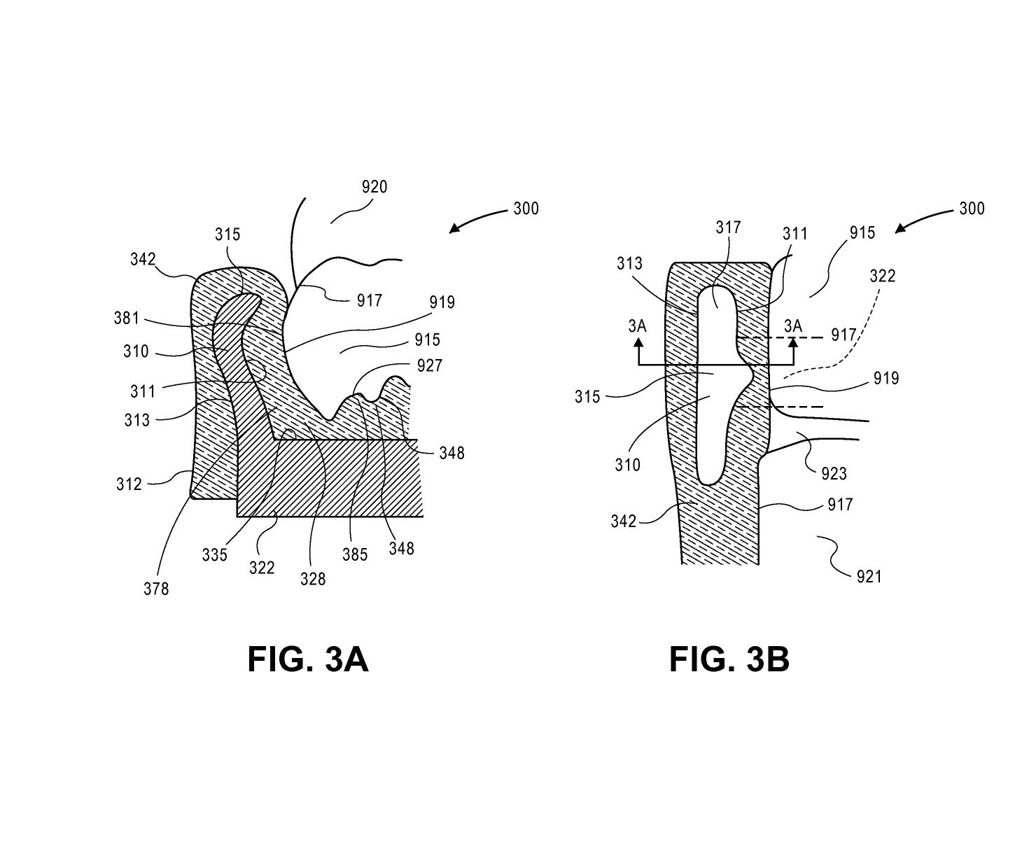

Occlusal pad 40 may, by virtue of its elasticity, tension itself about the teeth such that the occlusal pad 40 is generally attached to the teeth when teeth are engaged with occlusal pad channel. Inclusion of arms 150 160 with occlusal pad 40 may increase the tensioning of the occlusal pad 40 about the teeth thereby enhancing the attachment of occlusal pad 40 and, thus, the dental appliance 100 to the teeth. Note that arms 150, 160 are generally illustrated in the relaxed position in FIG. 1B. (See FIG. 3A for an illustration of an implementation of an arm 310 generally in the flexed position).

As illustrated in FIG. 1B, bite pad 12 of dental appliance 100 includes arms 110, 120 formed as a unitary structure with base 22, and arms 110, 120 are covered by occlusal pad 42. The arms 110, 120 may cooperate with occlusal pad 42 to attach the dental appliance 100 to the teeth. Arms 110, 120 extend forth from base 22 such that side 111 of arm 110, side 35 of base 22, and side 123 of arm 120 define channel 78, in this implementation. Occlusal pad 42, as illustrated, is formed over base 22 such that at least portions of occlusal pad 42 lie within channel 78. Channel 78 may be filled in part by the occlusal pad material of occlusal pad 42, and occlusal pad channel 48 may lie, at least in part, within channel 78. Arms 110, 120 lie generally along sides 81, 83, respectively, of occlusal pad channel 48, in this implementation. As illustrated in FIG. 1B, side 111 of arm 110 lies proximate side 81 of occlusal pad channel 48, and side 123 of arm 120 lies proximate side 83 of occlusal pad channel 48.

In the implementation of FIG. 1B, side 121 of arm 120 is oriented in the lingual direction and side 123 of arm 120 is oriented in the buccal-labial direction. When teeth are engaged with occlusal pad channel 48 of bite pad 12, side 83 of occlusal pad channel 48 is generally engaged with the lingual surfaces of the teeth, and side 81 of occlusal pad channel 48 is generally engaged with the buccal-labial surfaces of the teeth, in this implementation. The tips of the teeth including the biting surfaces may be generally biased against trough 85 of occlusal pad channel 48. Side 123 of arm 120 is biased against portions of the lingual surface of the teeth with portions of occlusal pad 42 proximate side 83 of occlusal pad channel 42 interposed between side 163 and the lingual surface, in this implementation. In other implementations (not shown), arm 120 may be partially covered by occlusal pad 42 (i.e. portions of arm 120 emerge from the occlusal pad 42) such that at least portions of side 123 of arm 120 directly contact portions of the lingual surfaces of the teeth.

Side 113 of arm 110 is oriented in the buccal-labial direction, and side 111 of arm 110 is oriented in the lingual direction, as illustrated in FIG. 1B. With teeth received in occlusal pad channel 48, side 111 of arm 110 is biased against portions of the buccal-labial surface of the teeth with portions of occlusal pad 42 proximate side 81 of occlusal pad channel 48 interposed between side 111 and the buccal-labial surface, in this implementation. In other implementations (not shown), arm 110 may be partially covered by occlusal pad 42 (i.e. portions of arm 110 emerge from the occlusal pad 42) such that at least portions of side 111 directly contact portions of the buccal-labial surfaces of the teeth.

When teeth are engaged with occlusal pad channel 48 of bite pad 12, the buccal-labial surfaces of one or more teeth push against arm 110, which forces arm 110 to flex in the buccal-labial direction from a relaxed position to a flexed position, in the implementation of FIG. 1B. Side 111 of arm 110 in the flexed position may be thus generally biased in tension against the buccal labial surfaces of the one or more teeth, in this implementation, with portions of occlusal pad 42 interposed between side 111 and the buccal labial tooth surfaces.

Similarly, when teeth are engaged with occlusal pad channel 48 of bite pad 12, the lingual surfaces of one or more teeth push against arm 120, which forces arm 120 to flex in the lingual direction from a relaxed position to a flexed position. Surface 123 of arm 120 in the flexed position may be thus generally biased in tension against the lingual surfaces of the one or more teeth, in this implementation, with portions of occlusal pad 42 intervening between side 123 and the lingual tooth surfaces.

Arm 120 in the flexed position and biased against the lingual surfaces one ore more teeth may exert a force thereupon generally acting in the buccal labial direction. Arm 110 in the flexed position and biased against the buccal-labial surfaces of one or more teeth may exert a force thereupon generally acting in the lingual direction. Thus, arms 110, 120 may exert forces upon opposite surfaces of the teeth in generally opposing directions so that the teeth may be clamped between arms 110, 120 thereby securing bite pad 12 of dental appliance 100 to the teeth. Occlusal pad 42 may, by virtue of its elasticity, tension itself about the teeth such that the occlusal pad 42 is generally secured to the teeth when teeth are engaged with occlusal pad channel. Combining arms 110, 120 with occlusal pad 42 may increase the tensioning of the occlusal pad 42 about the teeth thereby enhancing the attachment of occlusal pad 42 and, thus, bite pad 12 of dental appliance 100 to the teeth.

Surfaces 111, 123, 151, 163 of arms 110, 120, 150, 160 are curved in a direction oriented between a tooth tip and gum line, as illustrated in FIG. 1B, to generally conform to the surfaces of the teeth against which surfaces 111, 123, 151, 163 are generally biased. Surface 111 of arm 110 and surface 151 of arm 150 may be curved and otherwise formed to conform to the buccal-labial surfaces of the posterior teeth between tooth tip and gum line. When engaged with the teeth, portions of surface 111 of arm 110 including portions of surface 111 proximate tip 115 and surface 151 of arm 150 including portions of surface 151 proximate tip 155 may be biased against the buccal-labial surfaces. Surface 123 of arm 120 and surface 163 of arm 160 may be curved and otherwise formed to conform to the lingual surfaces of the posterior teeth. When engaged with the teeth, portions of surface 123 of arm 120 including portions of surface 123 proximate tip 125 and surface 163 of arm 160 including portions of surface 163 proximate tip 165 may be biased against the lingual surfaces.

As illustrated in FIG. 1B, arms 110, 150, which engage buccal-labial surfaces of posterior teeth are longer than arms 120, 160, which engage the lingual surfaces of the posterior teeth. The lengths of arms 110, 120, 150, 160 may be chosen so that tips 115, 125, 155, 165, respectively, engage the teeth without touching the gum. Arms 120, 160, which engage the lingual surfaces, may be generally shorter than arms 110, 150, as the length from the tooth tip to the gum line tends to be shorter on the lingual side than on the buccal-labial side. In the implementation of FIG. 1B, arms 150, 160 and arms 110, 120 are cantilevered from bases 20, 22, respectively, so that the largest tensional forces applied by arms 110, 120, 150, 160 to the teeth are generally proximate the tips 115, 125, 155, 165.

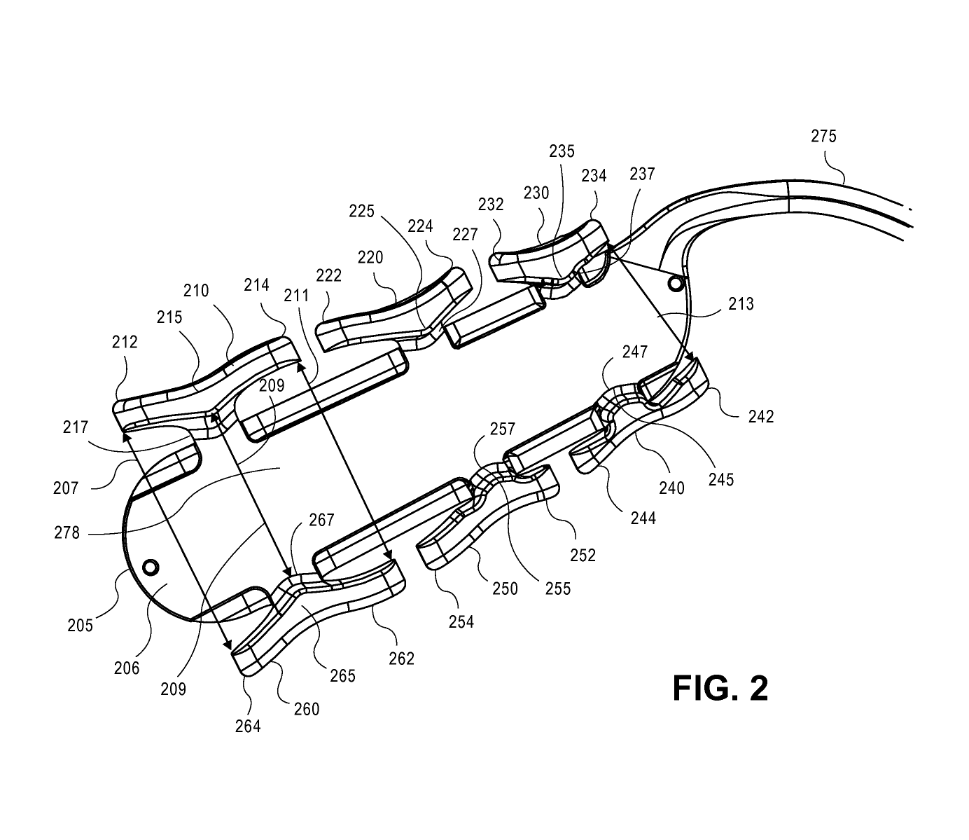

FIG. 2 illustrates portions of a dental appliance 200 including base 205 and labial bar 275 connected to base 205. As illustrated, ends 217, 227, 237, 247, 257, 267 of arms 210, 220, 230, 240, 250, 260 are attached at the base 205, respectively, such that arms 210, 220, 230, 240, 250, 260 are cantilevered from surface 206 of base 205. Although not shown in FIG. 2, an occlusal pad, such as occlusal pad 42 (see FIGS. 1A, 1B), is bonded to base 205 and arms 210, 220, 230, 240, 250, 260 in dental appliance 200. With continuing reference to FIG. 2, arms 210, 220, 230, 240, 250, 260 in combination with surface 206 of base 205 generally define channel 278, and teeth may be received in channel 278. Arm 210 is positioned across base 205 from arm 260, arm 220 is positioned across base 205 from arm 250, and arm 230 is positioned across base 205 from arm 240. Accordingly, when teeth are received in channel 278, arms 210, 220, 230, 240, 250, 260 are engaged with the teeth such at arms 210, 220, 230 are biased against the buccal-labial surfaces of the teeth and arms 240, 250, 260 are biased against the lingual surfaces of the teeth. Arms 210, 260 are biased against opposite surfaces of the teeth and exert forces thereupon opposing one another; arms 220, 250 are biased against opposite surfaces of the teeth and exert forces thereupon opposing one another; and, arms 230, 240 are biased against opposite surfaces of the teeth and exert forces thereupon opposing one another, in this implementation.

The arms 210, 220, 230, 240, 250, 260, in this implementation, are generally T-shaped with the base of the T formed into base 205 in a unitary manner. The upright portion of the T is curved to conform generally to the curvature of the tooth surface(s) between the tooth tip and the gum line, as illustrated, to allow the upright portion to be biased against the tooth surface(s) generally along the length of the upright portion. The crossing portion of the T, as illustrated in FIG. 2, is curved to allow for curvature of the tooth surface(s) in the anterior-posterior direction, so that the crossing portion of the T may be biased against the tooth surface(s)

Accordingly, there may be, for example, variation of the width of channel 278 from surface 206 of base 205 to tips 215, 265 of arms 210, 260, respectively, in order to accommodate the shapes of the teeth. Arm 210 has tip 215 and ends 212, 214 located along the crossing portion of the T, and arm 260 has tip 265 and ends 262, 264 located along the crossing portion of the T, as illustrated. The width of channel 278 varies in the anterior posterior direction in this implementation to accommodate the shapes of the teeth in the anterior-posterior direction. For example, channel 278 has width 207 between end 212 of arm 210 and end 264 of arm 260, channel width 209 between tip 215 of arm 210 and tip 265 of arm 260, and channel width 211 between end 214 of arm 210 and end 262 of arm 260. Channel width 211 is generally greater than channel width 209 and channel width 207 is generally greater than channel width 211 in this implementation. The channel width may of channel 278 may generally decrease in the anterior direction so that, for example, width 213 between end 234 of arm 230 and end 242 of arm 240, which is generally at the anterior end of base 205, is less than widths 207, 209, 211, which are generally at the posterior end of base 205.

The heights of arms 210, 220, 230, 240, 250, 260 may vary such that arms positioned posterior on base 205 may be longer than arms positioned at the anterior of base 205 to accommodate the greater size of the corresponding teeth. The occlusal pad (not shown in this Figure) may be generally shaped in conformance with arms 210, 220, 230, 240, 250, 260 and may be overlaid upon at least portions of arms 210, 220, 230, 240, 250, 260, in various implementations.

Arms 210, 220, 230, 240, 250, 260, channel 278, and the associated occlusal pads are shaped to engage the teeth in a generic manner as opposed to being custom conformed to engage the teeth of a particular user at particular pre-selected locations, in this implementation. The arms 210, 220, 230, 240, 250, 260 may engage the teeth generally on the buccal-labial surface(s) or generally on the lingual surface(s). Any of arms 210, 220, 230, 240, 250, 260 may engage the surface of one tooth, several teeth, and/or regions between the teeth depending upon how the arms 210, 220, 230, 240, 250, 260 happen to align with the teeth of a particular user. Dental appliance 200, as illustrated in FIG. 2, including arms 210, 220, 230, 240, 250, 260 is not customized for a particular user, and the arms 210, 220, 230, 240, 250, 260 are not targeted to engage the teeth at specific locations on the buccal-labial surfaces, the lingual surfaces, and the inter-dental region between adjacent teeth. By contrast, a custom-made dental appliance crafted, for example, by a dentist solely for a particular user may be attached at specified points on or about the teeth with these specified points having been identified and selected by the dentist at the time the custom-made dental appliance is fabricated.

FIGS. 3A and 3B illustrate portions of dental appliance 300 engaged with teeth 915, 921. As illustrated in FIG. 3A, arm 310 is formed as a unitary structure with base 322 and is cantilevered from base 322. Side 311 of arm 310 and side 335 of base 322 form a portion of channel 378. Occlusal pad 342 is formed over base 322 and arm 310 with portions of occlusal pad 342 received in channel 378. The occlusal pad 342, in turn, defines occlusal pad channel 348, and tooth 915 is received in occlusal pad channel 348, which is received generally within channel 378. Biting surface 927 of tooth 915 is generally biased against trough 385 of occlusal pad channel 348, and occlusal pad 342 thus covers the biting surface 927. Insertion of tooth 915 into occlusal pad channel forces arm 310 from a relaxed position into a flexed position, as illustrated in FIGS. 3A and 3B, such that side 311 of arm 310 is biased forceably against surface 919 of tooth 915 to engage dental appliance 300 with tooth 915. Accordingly, arm 310 is illustrated in flexed position in FIG. 3A. Portions of occlusal pad 342 are interposed between side 311 of arm 310 and surface 919 of tooth 915 in this implementation. In other implementations (not shown), at least portions of side 311 of arm 310 may directly contact portions of surface 919 of tooth 915. The material that forms arm 310 may be chosen such that arm 310 exhibits linear elastic behavior within the range of motion between the relaxed position and the flexed position.

Side 311 of arm 310 is curved, as illustrated, to conform generally to the curvature of surface 919 of tooth 915, which extends between gum line 917 and biting surface 927, so that side 311 of arm 310 is generally biased against surface 919 of tooth 915 throughout. The portions of occlusal pad 342 that generally overlay surface 311 may be similarly curved to conform to the curvature of surface 919. Custom fitting of the occlusal pad 342 to tooth 915 by heating of the occlusal pad 342 may enhance the conformation between the occlusal pad 342 and surface 919 of tooth 915. Arm 310 is sized so that tip 315 and portions of occlusal pad 342 that overlay tip 315 do not engage the gum 920 or the tooth proximate the gum line 917, as illustrated, in order to prevent discomfort to the user such as irritation of the gum 920.

FIG. 3B illustrates another view of arm 310. As illustrated in FIG. 3B, arm 310 has a T-shape with end 315 forming the crosspiece 317 of the T. Crosspiece 317 generally extends in the anterior-posterior direction in this implementation. Surface 311, which includes portions of crosspiece 317, is biased the surfaces of two teeth—against surface 919 of tooth 915 and surface 917 of tooth 921 as well as inter-dental region 923, as illustrated. Portions of occlusal pad 342 are interposed between side 311 and surfaces 917, 919 and inter-dental region 923, in this implementation. It should be recognized that this implementation of dental appliance 300 is generally configured for a generic user. Accordingly, in this implementation, surface 311 of arm 310 is formed to generally engage surface 917, surface 919 and/or inter-dental region 923. Surface 311 of arm 310 may engage any of surface 917, surface 919, inter-dental region 923, or combinations thereof as may happen to coincide with surface 311 of arm 310 as dental appliance 300 is employed by a particular user. As illustrated, surface 311 of arm 310 is biased against two teeth, tooth 915 and tooth 921. In other implementations or in other users of dental appliance 300, surface 311 of arm 310 may be biased against a single tooth, or more than two teeth.

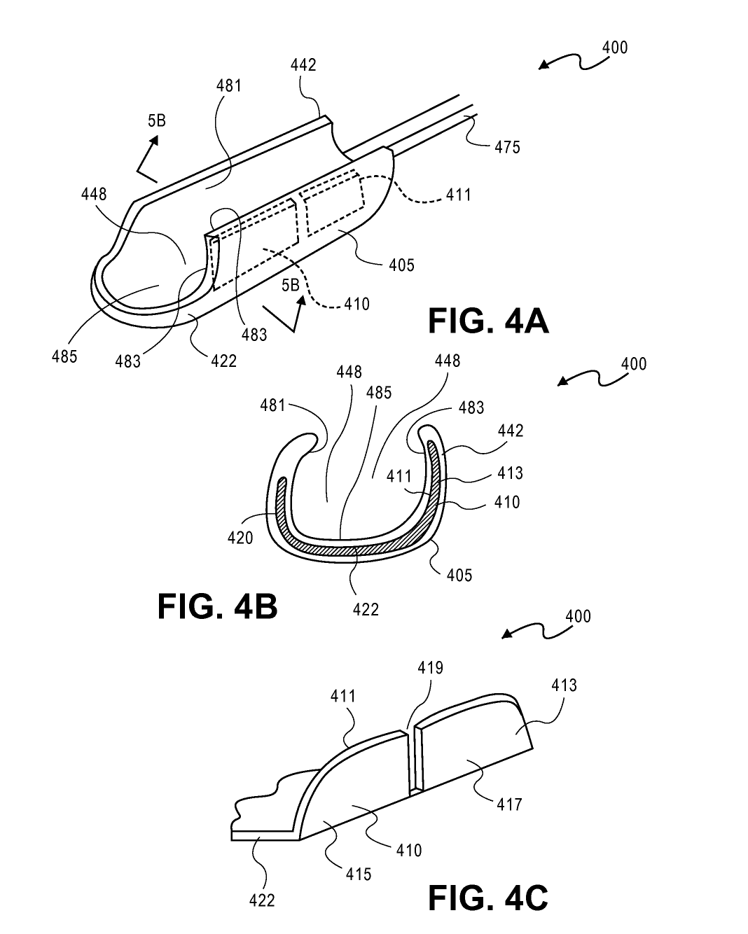

Portions of an implementation of dental appliance 400 are illustrated in FIGS. 4A, 4B, and 4C. As illustrated in FIG. 4A, dental appliance 400 includes bite pad 405 secured to labial bar 475. Bite pad 405 includes base 422 with occlusal pad 442 formed of occlusal pad material and over-molded upon the base 422. Sides 481 and 483 of occlusal pad 442 define occlusal pad channel 448 with trough 485, and channel 448 may receive posterior teeth of a user to secure the dental appliance 500 thereto. As illustrated in FIG. 4A, arm 410 is embedded within occlusal pad 442 to generally bias against portions of teeth adjacent side 483 of channel 448.

A cross section through bite pad 405 is illustrated in FIG. 4B. As illustrated, arms 410, 420 extend from base 422 and occlusal pad 442 is formed over arms 410, 420, and base 422. Arms 410, 420 have a generally curved shape to conform to surfaces of teeth that may be received in occlusal pad channel 448, so that arms 410, 420 may be biased against the teeth so received, as illustrated. Note that, in this implementation, surfaces 481, 483 of occlusal pad 442 are curved to conform to curved surfaces of teeth that may be received in occlusal pad channel 448.

Arm 410 is illustrated in detail in FIG. 4C. As illustrated in FIG. 4C, arm 410 is an elongate structure bifurcated into portion 415 and portion 417 by slot 419. Side 411 of arm 410 may be biased against multiple teeth, and either portion 415 and/or portion 417 of arm 410 may be biased against multiple teeth. Side 413 is opposite side 411, as illustrated.

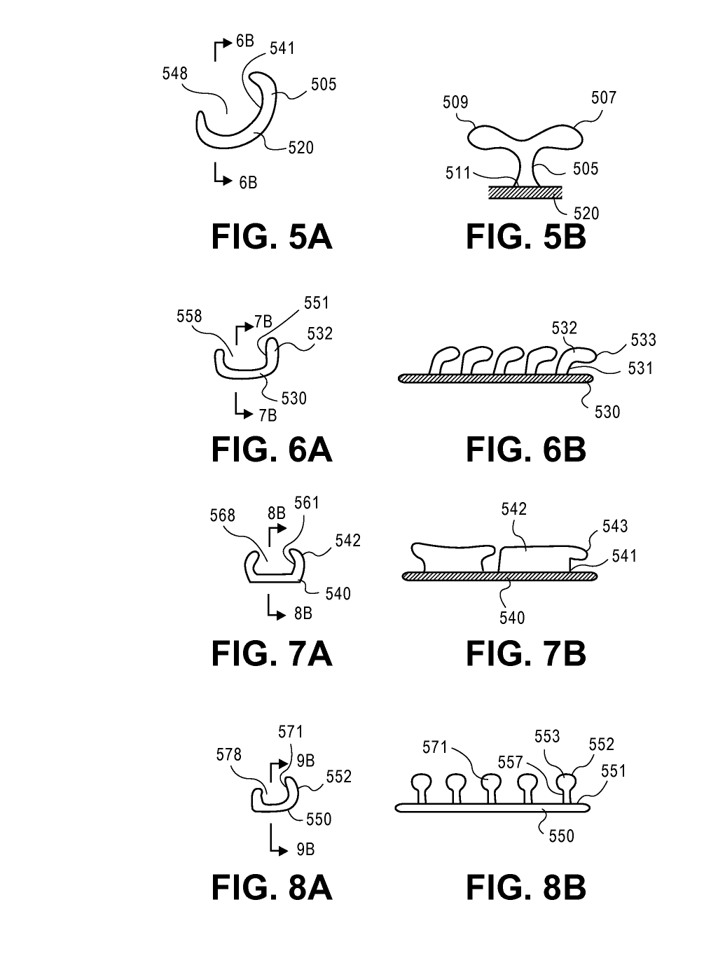

FIGS. 5A and 5B illustrate an implementation of arm 505 secured to base 520. An occlusal pad (not shown) surrounds base 520 and arms such as arm 505 secured thereto to define occlusal pad channel 548 in this implementation. Teeth may be received in occlusal pad channel 548 and arm 505 biases against surfaces of the teeth so received to secure the assembly to the teeth. In this implementation, arm 505 is curved to conform to the shapes of the surfaces of the teeth as illustrated in FIG. 5A. As illustrated in FIG. 5B, arm 505 is generally T-shaped with end 511 secured to base 520. Teardrop shaped portion 509 of arm 505 and teardrop shaped portion 507 of arm 505 are joined together to form the crosspiece of the T. A plurality of similar arms are may be disposed along the base 505 to form part of side 541 of occlusal pad channel 548.

FIGS. 6A and 6B illustrate an implementation of arm 532 secured to base 530. An occlusal pad (not shown) surrounds base 530 and arms, such as arm 532, secured thereto to define occlusal pad channel 558 in this implementation. Teeth may be received in occlusal pad channel 558, and arm 532 may bias against surfaces of the teeth so received to secure the assembly to the teeth. In this implementation, arm 532 is curved to conform to the shapes of the surfaces of the teeth as illustrated in FIG. 6A. As illustrated in FIG. 6B, arm 532 is generally L-shaped with end 531 secured to base 530. A plurality of such arms members are disposed along the base 530, as illustrated in FIG. 6B, to form part of side 551 of occlusal pad channel 558. Note that ends 533 are oriented in the same way in this implementation. In other implementations, ends 533 may be oriented in alternating directions, or otherwise alternated in various ways.

FIGS. 7A and 7B illustrate an implementation of arm 542 secured to base 540. An occlusal pad (not shown) surrounds base 540 and arms such as arm 542 secured thereto to define occlusal pad channel 568. Teeth may be received in occlusal pad channel 568, and arm 542 may bias against surfaces of the teeth so received to secure the assembly to the teeth. In this implementation, arm 542 is curved to conform to the shapes of the surfaces of the teeth, as illustrated in FIG. 7A. As illustrated in FIG. 7B, arm 542 is generally rectangular with a nose portion 543 opposite end 541 which is secured to base 540. A plurality of similar arms are disposed along the base 540, as illustrated in FIG. 7B, to form side 561 of occlusal pad channel 568. Noses 543 of successive arms 542 may be oriented in various ways in various implementations.

FIGS. 8A and 8B illustrate an implementation of arm 552 secured to base 550. An occlusal pad (not shown) surrounds base 550 and arms such as arm 552 secured thereto to define occlusal pad channel 578. Teeth may be received in occlusal pad channel 578 and arm 552 biases against surfaces of the teeth so received to secure the assembly to the teeth. In this implementation, arm 552 is curved to conform to the shapes of the surfaces of the teeth as illustrated in FIG. 8A. As illustrated in FIG. 8B, arm 552 includes a rounded portion 553 connected to end 551, which is secured to base 550, by stalk 557. Rounded portion 553 may bias against the teeth generally proximate the gum line. A plurality of similar arms 552 are disposed along the base 550, as illustrated in FIG. 8B, to form side 571 of occlusal pad channel 578.

In use, the dental appliance, such as dental appliance 100, 200, 300, 400, may be fit to the user's mouth by heating the dental appliance in hot water to soften the occlusal pad material of the occlusal pad, such as occlusal pad 40, 42, 342, 442 into a pliable state. With the occlusal pad in the pliable state, the user may position the dental appliance in the mouth, and then may engage the occlusal pad of the dental appliance by biting generally the occlusal pad channel, such as occlusal pad channel 46, 48, 385, 448, 548, 558, 568, 578, such that the teeth are received therein. When the user bites the occlusal pad channel, the occlusal pad, which is in the pliable state, deforms until the occlusal pad including the occlusal pad channel assumes a shape that conforms to the user's teeth—i.e. the shape of the user's teeth is impressed into the occlusal pad. Thus, the occlusal pad, including occlusal pad channel(s) therein, is custom alterable to fit the user. The temperature at which the occlusal pad material of the occlusal pad becomes pliant is, for example, generally tolerable by the user when the user engages in this fitting process. Tolerable to the user, in various implementations, means unobjectionable to the user and non-injurious to the user. After the occlusal pad has conformed to the teeth, the user may cool the occlusal pad by, for example, taking cool water into the mouth. Upon being cooled, the occlusal pad is transformed into the non-pliant state in which the occlusal pad material recovers sufficient rigidity to retain its shape, which now conforms to the user's teeth as imprinted upon the occlusal pad by biting thereupon. The dental appliance is now fitted to the user's mouth.

Subsequent to being fitted to the user's mouth, the user may position the dental appliance in the mouth such that the occlusal pad receives the teeth to which it conforms such that the occlusal pad covers at least portions of the teeth including the biting surfaces of the teeth. Arms, such as arms 110, 120, 210, 220, 230, 240, 250, 260, 310, 410, 420, 505, 532, 542, 552, may be biased in tension against the teeth to grip the teeth in order to secure the dental appliance. The dental appliance is, accordingly, removably secured to the teeth by frictional engagement with the user's teeth.

In various aspects, the process of securing the dental appliance to the teeth may include the steps of receiving a tooth within a custom alterable channel of an occlusal pad, biasing an arm against a buccal-labial surface of the tooth, the arm generally in cooperation with the occlusal pad, and clamping the tooth by biasing an arm generally in cooperation with the occlusal pad against a lingual surface of the tooth, the arm biased against the lingual surface generally in opposition to the arm biased against the buccal-labial surface of the tooth.

The foregoing discussion along with the Figures discloses and describes various exemplary implementations. These implementations are not meant to limit the scope of coverage, but, instead, to assist in understanding the context of the language used in this specification and in the claims. Accordingly, variations of the apparatus, methods, and compositions of matter that differ from these exemplary implementations may be encompassed by the appended claims. Upon study of this disclosure and the exemplary implementations herein, one of ordinary skill in the art may readily recognize that various changes, modifications and variations can be made thereto without departing from the spirit and scope of the inventions as defined in the following claims.

What is claimed is:

1. An dental appliance, comprising:
an occlusal pad formed from an occlusal pad material transformable between a pliable state and a non-pliable state, the occlusal pad defining a channel adapted to receive a tooth including at least a portion of the buccal-labial surface of the tooth and at least a portion of the lingual surface of the tooth and such that the occlusal pad covers a biting surface of the tooth;
a buccal-labial arm positioned on a buccal-labial side of the channel in cooperation with the occlusal pad to bias generally against the buccal-labial surface of the tooth; and
a lingual arm positioned on a lingual side of the channel generally opposite the buccal-labial arm, the lingual arm in cooperation with the occlusal pad to bias generally against the lingual surface of the tooth.

2. The apparatus, as in claim 1, further comprising:
a bite pad comprising the occlusal pad with arm positioned on the buccal-labial side of the channel and arm positioned on the lingual side of the channel, the bite pad securable to posterior teeth;
a second bite pad comprising a second occlusal pad with arm positioned on the buccal-labial side of the channel and arm positioned on the lingual side of the channel, the second bite pad securable to posterior teeth on the opposite side of the mouth from the bite pad; and
a labial bar positionable about the user's anterior teeth that links the bite pad with the second bite pad.

3. The apparatus, as in claim 2, wherein the labial bar is positioned on the lingual side of the anterior teeth.

4. The apparatus, as in claim 1, wherein the channel is adapted to receive a tooth in the posterior portion of the mouth.

5. The apparatus, as in claim 1, wherein the channel is adapted to receive a tooth in the lower jaw.

6. The apparatus, as in claim 1, wherein the channel is adapted to receive a tooth in the upper jaw.

7. The apparatus, as in claim 1, wherein the arm is curved to generally conform to a curvature of the tooth surface to allow engagement of the side of the arm with the surface of the tooth.

8. The apparatus, as in claim 1, wherein an arm end of the arm engages the tooth generally distal of the gum-line to avoid intrusion upon the gum.

9. The apparatus, as in claim 1, further comprising:
an arm material constitutive of the arm and having linear elastic properties in the range generally between a relaxed arm position and an engaged arm position.

10. The apparatus, as in claim 1, further comprising:
an occlusal pad material constitutive of the occlusal pad, the occlusal pad material comprised of a material chosen from the from the group consisting of polycaprolactone, ethylene vinyl acetate, and polyolefin elastomer.

11. The apparatus, as in claim 1, wherein the arm positioned on the buccal-labial side of the channel is configured generally in a T-shape.

12. The apparatus, as in claim 1, wherein the arm positioned on the lingual side of the channel is configured generally in a T-shape.

13. The apparatus, as in claim 1, wherein the arm positioned on the lingual side of the channel is configured generally as a bifurcated elongate structure.

14. The apparatus, as in claim 1, wherein the arm positioned on the lingual side of the channel is entirely embedded within the occlusal pad such that portions of the occlusal pad are interposed between the arm and the lingual surface of the tooth.

15. The apparatus, as in claim 1, wherein the arm positioned on the buccal-labial side of the channel is entirely embedded within the occlusal pad such that portions of the occlusal pad are interposed between the arm and the buccal-labial surface of the tooth.

16. The apparatus, as in claim 1, wherein the arm positioned on the lingual side of the channel cooperates with the occlusal pad such that at least portions of the arm directly contact the lingual surface of the tooth.

17. The apparatus, as in claim 1, wherein the arm positioned on the buccal-labial side of the channel cooperates with the occlusal pad such that at least portions of the arm directly contact the buccal-labial surface of the tooth.

18. The apparatus, as in claim 1, wherein at least one of the arms has a shape selected from a group of shapes consisting of T shape, L shape, rectangular, rectangular with nose, stalk with rounded end.

19. A method of attaching a dental appliance to the teeth, comprising the steps of:
receiving a tooth within a custom alterable channel of an occlusal pad;
biasing an arm against a buccal-labial surface of the tooth, the arm generally in cooperation with the occlusal pad; and
biasing an arm against a lingual surface of the tooth, the arm biased against the lingual surface is generally in cooperation with the occlusal pad, the arm biased against the lingual surface is generally opposed to the arm biased against the buccal-labial surface of the tooth thereby clamping the tooth therebetween.

20. The method, as in claim 19, further comprising the step of:
positioning a labial bar proximate the anterior teeth, the labial bar connecting a bit pad to a second bit pad of said dental appliance.
